(19) United States
(12) Patent Application Publication
(10) Pub. No.: US 2022/0183011 A1
(43) Pub. Date: Jun. 9, 2022

(54) METHODS AND DEVICES FOR RECEIVING DATA AND CONTROLLING THE SAME

(71) Applicant: BEIJING UNISOC COMMUNICATIONS TECHNOLOGY CO., LTD., Beijing (CN)

(72) Inventor: Hualei WANG, Beijing (CN)

(21) Appl. No.: 17/678,214

(22) Filed: Feb. 23, 2022

Related U.S. Application Data
(63) Continuation of application No. PCT/CN2020/108907, filed on Aug. 13, 2020.

(30) Foreign Application Priority Data
Aug. 23, 2019 (CN) 201910784976.5

(51) Int. Cl. H04W 72/04; H04L 27/26

(52) U.S. Cl. CPC H04W 72/0486; H04W 72/042; H04L 27/2628; H04W 72/0453; H04W 72/0446

(57) ABSTRACT

This disclosure relates to methods and devices for receiving data and controlling the receiving of the data. An exemplary method may be performed by a user equipment and comprise: receiving Downlink Control Information (DCI), the DCI comprising a bandwidth update indicator field and a transmission bandwidth indicator field, the transmission bandwidth indicator field comprising transmission bandwidth information indicative of a frequency domain location; determining that the bandwidth update indicator field includes an instruction for updating a transmission bandwidth; in response to the determining that the bandwidth update indicator field includes the instruction for updating the transmission bandwidth, updating the transmission bandwidth based on the transmission bandwidth information; and receiving data using the updated transmission bandwidth.

### CROSS REFERENCE TO RELATED APPLICATIONS

This application is a continuation of International Application No. PCT/CN2020/108907, filed Aug. 13, 2020, which is based on and claims priority to Chinese Patent Application No. 201910784976.5, filed Aug. 23, 2019, the entire contents of all of which are incorporated herein by reference.

### TECHNICAL FIELD

This disclosure relates to the field of communication technology and, more particularly, to methods and devices for receiving data and controlling the same.

### BACKGROUND

In a system that uses a single-carrier waveform in its downlink (DL), such as a satellite system or a high frequency system, data transmission bandwidth is at cell level. In other words, all users in a cell have the same transmission bandwidth. As the traffic in a cell changes dynamically, the transmission bandwidth should also be changed dynamically to reduce network overhead or terminal overhead.

However, with respect to downlink Semi-Persistent Scheduling (DL SPS) transmission, once a DL SPS periodic resource is activated by activation Downlink Control Information (DCI), a user equipment will receive data in the activated periodic resource. Therefore, a terminal configured with DL SPS does not dynamically obtain a system's transmission bandwidth information and thus cannot adapt to dynamic changes in the traffic of its cell, thereby affecting the decoding performance of the terminal and the user experience.

### SUMMARY

According to a first aspect of the present disclosure, there is provided a method for receiving data, the method comprising: receiving Downlink Control Information (DCI), the DCI comprising a bandwidth update indicator field and a transmission bandwidth indicator field, the transmission bandwidth indicator field comprising transmission bandwidth information indicative of a frequency domain location; determining that the bandwidth update indicator field includes an instruction for updating a transmission bandwidth; in response to the determining that the bandwidth update indicator field includes the instruction for updating the transmission bandwidth, updating the transmission bandwidth based on the transmission bandwidth information; and receiving the data using the updated transmission bandwidth.

According to a second aspect of the present disclosure, there is provided a method performed by a network element equipment, the method comprising: sending downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

According to a third aspect of the present disclosure, receive Downlink Control Information (DCI), the DCI comprising a bandwidth update indicator field and a transmission bandwidth indicator field, the transmission bandwidth indicator field comprising transmission bandwidth information indicative of a frequency domain location; determine that the bandwidth update indicator field includes an instruction for updating a transmission bandwidth; in response to the determining that the bandwidth update indicator field includes the instruction for updating the transmission bandwidth, update the transmission bandwidth based on the transmission bandwidth information; and receive the data using the updated transmission bandwidth.

According to a fourth aspect of the present disclosure, there is provided a control device comprising a processor and a memory device for storing instructions executable by the processor. The processor is configured to execute the instructions to: send downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

According to a fifth aspect of the present disclosure, there is provided a non-transitory computer readable storage medium storing a computer program that, when executed by a processor, causes the processor to perform a method for receiving data, the method comprising: receiving Downlink Control Information (DCI), the DCI comprising a bandwidth update indicator field and a transmission bandwidth indicator field, the transmission bandwidth indicator field comprising transmission bandwidth information indicative of a frequency domain location; determining that the bandwidth update indicator field includes an instruction for updating a transmission bandwidth; in response to the determining that the bandwidth update indicator field includes the instruction for updating the transmission bandwidth, updating the transmission bandwidth based on the transmission bandwidth information; and receiving the data using the updated transmission bandwidth.

According to a sixth aspect of the present disclosure, there is provided a non-transitory computer readable storage medium storing a computer program that, when executed by a processor, causes the processor to perform a method, the method comprising: sending downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

It is to be understood that both the foregoing general description and the following detailed description are exemplary and explanatory only and are not restrictive of the invention, as claimed.

### BRIEF DESCRIPTION OF THE DRAWINGS

Drawings contained in the Description and constituting a part of the Description, together with the Description, show exemplary embodiments, features, and aspects of the disclosure and are used for explaining principles in the disclosure.

FIG. 1 is a schematic diagram illustrating a communication system, according to an exemplary embodiment of the present disclosure.

FIG. 2 is a flowchart of a data receiving method, according to an exemplary embodiment of the present disclosure.

FIG. 3 is a diagram illustrating receiving of data, according to an exemplary embodiment of the present disclosure.

FIG. 4 is a flowchart of a control method, according to an exemplary embodiment of the present disclosure.

FIG. 5 is a block diagram of a data receiving device, according to an exemplary embodiment of the present disclosure.

FIG. 6 is a block diagram of a control device, according to an exemplary embodiment of the present disclosure.

FIG. 7 is a block diagram of a data receiving device, according to an exemplary embodiment of the present disclosure.

FIG. 8 is a block diagram of a communication device, according to an exemplary embodiment of the present disclosure.

### DETAILED DESCRIPTION

Exemplary embodiments, features, and aspects of the disclosure will be described below in detail in reference to the drawings. Identical markings in the drawings represent elements that have the same or similar functions. Although the drawings illustrate various aspects of the embodiments, the drawings are not necessarily created in proportion unless specifically indicated so.

The specific term “exemplary” in this document means “being used as an example or embodiment, or illustrative.” In this document, any embodiment that is described as “exemplary” is not necessarily interpreted as being superior or better than other embodiments.

Additionally, many specific details are provided in the detailed description below to better describe the disclosure. Persons of ordinary skill in the art should understand that the disclosure may be implemented even without certain specific details. In some embodiments, no detailed description is provided on methods, means, elements, and circuits that are well known to persons of ordinary skill in the art so as to highlight the subject matter of the disclosure.

Embodiments according to this disclosure may be used in 5G (5th generation) communication systems, 4G communication systems, 3G communication systems, 2G communication systems, satellite communication systems, or various communication systems that may evolve in the future, such as 6G and 7G communication systems.

Embodiments in this disclosure may also be used for various network architectures, including but not limited to relay network architecture, dual link architecture, and vehicle-to-everything architecture.

“5G CN”, as mentioned in the embodiments in this disclosure, may also be referred to as new core network, 5G New Core, Next Generation Core (NGC) network, etc. The 5G-CN is configured independently from existing core networks, such as Evolved Packet Core (EPC) networks.

In the embodiments provided in this disclosure, a network element equipment may be a base station (BS), also referred to as base station equipment, which is a device deployed in a Radio Access Network (RAN) to provide wireless communication functions. Examples of equipments that provide base station functions include Base Transceiver Stations (BTS) and Base Station Controllers (BSC) in 2G networks, Nodes B and Radio Network Controllers (RNC) in 3G networks, evolved Nodes B (eNB) in 4G networks, Access Points (AP) in Wireless Local Area Networks (WLAN), next-generation Nodes B (gNB) in 5G New Radio (NR), and equipments that provide base station functions in future communication systems.

In the embodiments provided in this disclosure, a user equipment (UE) may refer to an access terminal, user unit, user station, mobile station (MS), remote station, remote terminal, mobile equipment, user terminal equipment, terminal equipment, wireless communication equipment, user agent, or user device of various forms. The user equipment may also be a cellular phone, cordless phone, Session Initiation Protocol (SIP) phone, Wireless Local Loop (WLL) station, Personal Digital Assistant (PDA), handheld equipment with wireless communication functions, computing equipment or processing equipment connected to a wireless modem, in-vehicle equipment, wearable equipment, user equipment in a future 5G network, terminal equipment in a Public Land Mobile Network (PLMN) evolved in the future, etc. The embodiments in the disclosure do not impose any limitation on the types of network element equipment or user equipment.

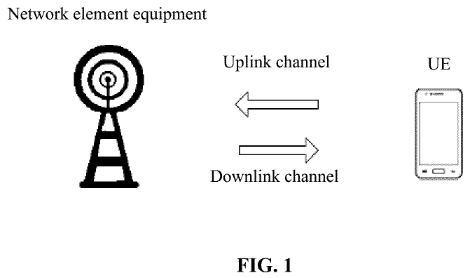

FIG. 1 is a schematic diagram illustrating a communication system, according to an exemplary embodiment of this disclosure. Various embodiments in this disclosure may be implemented in the communication system illustrated in FIG. 1. In the embodiments provided in the disclosure, a downlink (DL) is defined as a one-way communication link from an access network to a user equipment (UE). Downlink data is data transmitted on a downlink. The direction of transmission of downlink data is referred to as the downlink direction. An uplink (UL) is defined as a one-way communication link from a UE to an access network. Uplink data is data transmitted on an uplink. And the direction of transmission of uplink data is referred to as the uplink direction.

It should be understood that the term “and/or” in this document simply describes the relationship between related subjects. This term may indicate three possible relationships. For example, “A and/or B” may indicate: A alone, A and B, or B alone. Additionally, the symbol “/” in this document indicates an “or” relationship between the related subjects that precedes and follows it, respectively.

“Connection/connect” in the embodiments of the present disclosure refers to a direct or indirect connection by various means to implement communication between equipments, e.g., connecting different equipments through a communication interface. The embodiments in the disclosure do not impose any limitation in this regard.

In the embodiments of the present disclosure, “network” and “system” are meant to express the same concept, i.e., a communication system being a communication network.

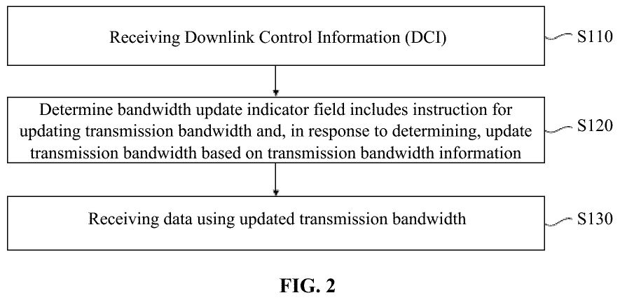

FIG. 2 is a flowchart of a data receiving method, according to an exemplary embodiment of this disclosure. For example, the method may be performed by a user equipment. As shown in FIG. 2, the method includes steps S110-S130.

At step S110, the user equipment may receive Downlink Control Information (DCI). The DCI includes a bandwidth update indicator field and a transmission bandwidth indicator field. The transmission bandwidth indicator field includes transmission bandwidth information indicative of a frequency domain location.

At step S120, the user equipment may determine that the bandwidth update indicator field includes an instruction for updating a transmission bandwidth and, in response to the determining, update the transmission bandwidth based on the transmission bandwidth information.

At step S130, the user equipment may receive data using the updated transmission bandwidth.

Using the disclosed methods, the transmission bandwidth may be updated dynamically based on the information included in the DCI, to allow the transmission bandwidth to be updated to match dynamic network traffic demands as network traffic changes dynamically, thereby improving system efficiency and communication experience.

In this disclosure, the updating of a transmission bandwidth may be understood as updating a transmission bandwidth that is used for a user equipment to receive or decode data. The updating of a transmission bandwidth may also be understood as updating transmission bandwidth information for receiving or decoding data. In this disclosure, the updating using an updated transmission bandwidth may be understood as using transmission bandwidth information in DCI to update transmission bandwidth information that is used for the user equipment to receive data. The receiving of the data using updated transmission bandwidth may be understood as using the updated transmission bandwidth information to receive the data.

It should be noted that at step S130, receiving the data using the updated transmission bandwidth may include receiving data and/or decoding the received data using the updated transmission bandwidth. After using the transmission bandwidth information to update the transmission bandwidth, the user equipment may determine a time when the updated transmission bandwidth takes effect for receiving data or performing decoding on a data channel.

In an exemplary embodiment, the frequency domain location may include a starting point of the frequency domain (e.g., a starting frequency), a frequency domain resource length (e.g., a bandwidth size), and other information.

In an exemplary embodiment, the data receiving method according to this disclosure may be used in a plurality of scenarios to update the transmission bandwidth that is used for the user equipment to receive data.

In one example, the data receiving method according to this disclosure may be used in a downlink Semi-Persistent Scheduling (DL SPS) scenario. This scenario will be used in the following description as an example to describe this disclosure. However, it should be understood that this disclosure is not limited to this scenario. In other embodiments, the data receiving method according to this disclosure may be applied in scenarios other than the DL SPS scenario.

When the data receiving method is used in the DL SPS scenario, this disclosure may, through the aforementioned method in FIG. 2, dynamically update a DL SPS transmission bandwidth based on the DCI's indication, allowing the DL SPS transmission bandwidth to be updated to match dynamic network traffic demands as network traffic changes dynamically, thereby improving system efficiency and communication experience.

In an exemplary embodiment, the DCI may be universal DCI for a plurality of user equipments or dedicated DCI for a specific (i.e., single) user equipment.

The universal DCI may be a piece of common DCI. The common DCI may have a universal DCI format for a plurality of user equipments. When a plurality of user equipments in a network are configured with DL SPS, using the universal DCI to update transmission bandwidths of the plurality of user equipments in the network may improve operating efficiency and reduce network overhead.

The dedicated DCI may be a piece of UE-specific DCI. For different user equipments. Different dedicated DCIs may be used to update DL SPS transmission bandwidths for different user equipments respectively, thereby meeting the needs of different user equipments and increasing adaptability and flexibility.

Persons of ordinary skill in the art may choose whether to use a universal DCI or a dedicated DCI to update a DL SPS transmission bandwidth according to their needs. This disclosure does not impose any limitation in this regard.

In an exemplary embodiment, the size of the DCI is the same as the size of DCI format 1_0.

In this disclosure, the DCI used for updating the transmission bandwidth may be the same or similar in size as a commonly used DCI format, so the methods described in the disclosure may be consistent with and adaptable to a current communication system, thereby reducing the complexity of blind searches performed by user equipments.

This disclosure uses the DCI format 1_0 as an example in the description. However, it should be understood that this disclosure is not limited to DCI format 1_0. In other embodiments, persons of ordinary skill in the art may configure the size of the DCI disclosed herein to be the same as or similar to the size of another DCI format.

In an exemplary embodiment, the DCI in this disclosure may include one of more of the following fields: a DCI format identifier field, indicated by 1 bit; a resource assignment field, all bits set to 1; a time domain resource assignment field, all bits set to 1; a transmission bandwidth indicator field, which is indicated by 4 bits and may be used for carrying the transmission bandwidth information; a modulation and coding scheme field, indicated by 5 bits; a new data indicator field, indicated by 1 bit; a redundancy version field, indicated by 2 bits; a HARQ process number field, indicated by 6 bits; a TPC command field, indicated by 2 bits; and a PUCCH resource indicator field, indicated by 4 bits, etc.

Of course, the description above is exemplary and should not be seen as limitation on this disclosure. In other embodiments, the number of DCI fields may increase or decrease, and the size of each field may change.

In an exemplary embodiment, at step 5120, determining that the bandwidth update indicator field includes an instruction for updating a transmission bandwidth may comprise: determining, when the bandwidth update indicator field carries preset indicator information, that the bandwidth update indicator field indicates the transmission bandwidth to be updated.

In one example, the preset indicator information may be information in which bits in the bandwidth update indicator field are all 1s or all 0s.

According to this disclosure, it is determined, when the bandwidth update indicator field carries the preset indicator information, that the bandwidth update indicator field indicates the transmission bandwidths to be updated, so the transmission bandwidth is updated, thus enabling simpler operations and reducing implementation complexity.

In an exemplary embodiment, the bandwidth update indicator field may be a new field or an existing field in the DCI. For example, the bandwidth update indicator field may include at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment. And the instruction for updating the transmission bandwidth may be indicated by bits in the resource assignment field being all 1s or all 0s, or indicated by bits in the time domain resource assignment field being all 1s or all 0s.

In some embodiments, the bandwidth update indicator field may be implemented using a resource assignment field already existing in the DCI, using a time domain resource assignment field, or using a combination thereof.

Of course, in other embodiments, the bandwidth update indicator field may alternatively be implemented using other fields in the DCI. This disclosure does not impose any limitation in this regard.

When the user equipment receives the resource assignment field with its bits being all 1s or all 0s and/or the time domain resource assignment field with its bits being all 1s or all 0s, the user equipment may determine that the network element equipment is transmitting the DCI to indicate the transmission bandwidth to be updated.

Of course, in other embodiments, the resource assignment field and/or time domain assignment field, or other fields used for implementing the bandwidth update indicator may be set to other values. For example, all bits may be 0, or the bits may be another combination of 0s and 1s. This disclosure does not impose any limitation in this regard.

In an exemplary embodiment, the DCI may be used only for updating the transmission bandwidth. In this scenario, when the user equipment receives the resource assignment field with its bits being all 1s or all 0s and/or the time domain resource assignment field with its bits being all 1s or all 0s, the user equipment may determine that the network element equipment is transmitting the DCI to indicate the transmission bandwidth to be updated, and the DCI is used only for updating the transmission bandwidth.

In an exemplary embodiment, at step S110, receiving DCI, may include: descrambling the DCI using a preset Radio Network Temporary Identifier (RNTI).

This disclosure may be used for updating transmission bandwidths of a plurality of user equipments, and the frequency domain location may carry data of one or a plurality of user equipments.

In an exemplary embodiment, the network element equipment, when sending the DCI, may scramble the DCI using a preset RNTI.

This disclosure does not impose any limitation on the preset RNTI. Persons of ordinary skill in the art may choose an RNTI (e.g. U-RNTI) according to their needs.

In an exemplary embodiment, at step S130, the receiving of the data using the transmission bandwidth may include: determining, based on the frequency domain location, a Discrete Fourier Transform (DFT) length and a frequency domain resource mapped from a DFT output, and using the DFT length to perform an Inverse Discrete Fourier Transform (IDFT) on the received data; or determining, based on the frequency domain location, an Inverse IDFT input and an IDFT length, and using the IDFT input and IDFT length to perform an IDFT on the received data.

In one example, when a DL SPS interval arrives, the user equipment may receive data in a DL SPS resource (e.g., SPS slot) and process the data (e.g. decode the data). In this scenario, this user equipment may, based on the transmission bandwidth information, determine a DFT length and a frequency domain resource mapped from a DFT output. The user equipment may then use the DFT length to perform an IDFT on the data received. Alternatively, the user equipment may, based on the transmission bandwidth information, determine an IDFT input and an IDFT length. The user equipment may then use the IDFT input and IDFT length to perform an IDFT on the data received.

In one example, it is assumed that the length of a frequency domain resource in the transmission bandwidth information includes K consecutive subcarriers. Then the DFT length may be determined to be K.

Persons of ordinary skill in the art may refer to relevant techniques for determining the DFT length, the frequency domain resource mapped from the DFT output, or the IDFT input and length. Persons of ordinary skill in the art may also refer to relevant techniques for using the DFT length, or using the IDFT input and IDFT length, to perform an IDFT on the data received. The details for these techniques will not be repeated in this disclosure.

In an exemplary embodiment, after the step S120, using the transmission bandwidth information to update a transmission bandwidth when the bandwidth update indicator field indicates the transmission bandwidth to be updated, the user equipment may receive data in a specified time unit. In other words, an effective time for the updated transmission bandwidth to take effect may be specified as needed. For illustrative purposes, examples are provided below.

In an exemplary embodiment, at step S130, the receiving of the data using the updated transmission bandwidth may include: using the updated transmission bandwidth to receive the data in a time unit.

As an example, the updated transmission bandwidth information may be used to receive data in a current time unit in which the DCI is received. Thus, it may be specified that the updated transmission bandwidth information takes effect only in the current time unit in which the DCI is received.

In an exemplary embodiment, at step S130, the receiving of the data using the updated transmission bandwidth may include: using the updated transmission bandwidth to receive the data in a plurality of time units.

For example, the updated transmission bandwidth information may apply in a plurality of time units of n+T1, n+T1+1, . . . , n+T2. Here, n may represent the time unit in which the DCI is received, T1 is a natural number with a unit of time unit, T2 is a natural number with a unit of time unit, and T2>=T1.

Of course, the plurality of time units may also be specified otherwise, and this disclosure does not impose any limitation on specific time units that are specified.

In an exemplary embodiment, at step S130, the receiving of the data using the updated transmission bandwidth may include: using the updated transmission bandwidth to receive the data in one or more time units, until the user equipment receives another DCI for updating the transmission bandwidth.

For example, the updated transmission bandwidth information may be applied in all time units (slots) after n+T3 (the second time unit), until another DCI indicating updated data transmission bandwidth information is received. Here, n may represent the time unit in which the DCI is received, T3 is a natural number with a unit of time unit.

Of course, this disclosure does not impose any limitation on any specific second time unit that is specified.

In an exemplary embodiment, the time unit may include at least one of the following: a slot, a set of slots, a subframe, a frame, a symbol, or a set of symbols.

In an exemplary embodiment, the effective time unit in which the updated transmission bandwidth information takes effect may be determined based on a protocol.

Of course, in other embodiments, other effective time units may be indicated by protocols. This disclosure does not impose any limitation in this regard.

Through the aforementioned method, the user equipment may determine the time unit in which the updated transmission bandwidth information takes effect, thereby adapting to different network traffic situations.

With regard to using updated transmission bandwidth to receive data, a description is provided below in reference to a specific example.

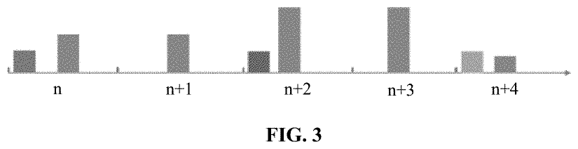

FIG. 3 is a diagram illustrating receiving of data, according to an exemplary embodiment of the present disclosure.

As shown in FIG. 3, the user equipment has a DL SPS resource configured by the network element equipment, and receives an activation DCI in slot n; so the user equipment, in slot n, assumes the transmission bandwidth for data to be a transmission bandwidth indicated by the activation DCI, and, at this time, the user equipment uses the transmission bandwidth indicated by the activation DCI to receive data.

In slot n+1, the user equipment does not receive any DCI that updates the transmission bandwidth, so the user equipment assumes that the transmission bandwidth for data is still the transmission bandwidth indicated by the activation DCI.

In slot n+2, the user equipment receives DCI that updates the transmission bandwidth, so the user device determines that the transmission bandwidth for data in slot n+2 is a transmission bandwidth indicated by the DCI that updates the transmission bandwidth.

In slot n+3, the user equipment does not receive any DCI that updates the transmission bandwidth, so the user equipment determines that the transmission bandwidth for data is still the transmission bandwidth indicated by the DCI received in slot n+2 that updates the transmission bandwidth.

In slot n+4, the user equipment receives another piece of DCI that updates the transmission bandwidth, so the user device determines that the transmission bandwidth for data in slot n+4 is a transmission bandwidth indicated by the DCI that updates the transmission bandwidth.

It should be noted that the description above is exemplary and should not be seen as limitation on the disclosure.

Through the methods described above, various embodiments according to this disclosure may implement dynamic updating of the DL SPS transmission bandwidth of the user equipment to match dynamic network traffic demands.

In the above description, the dynamic updating of the DL SPS transmission bandwidth of the user equipment is used as an example for description purposes. However, the disclosure is not limited to this scenario, and the method described in this disclosure may also be used in other scenarios.

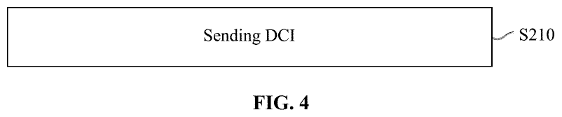

FIG. 4 is a flowchart of a control method, according to an exemplary embodiment of this disclosure. For example, the method may be performed by a network element equipment. As shown in FIG. 4, the method may include step S210.

Specifically, at step S210, the network element equipment may send downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

Through the method above, this network element equipment may send DCI that carries indication on whether to update the transmission bandwidth to provide indication to a user equipment, thus controlling the user equipment to update the transmission bandwidth when the bandwidth update indicator field is used to indicate the transmission bandwidth to be updated.

In an exemplary embodiment, the DCI includes a piece of universal DCI for a plurality of user equipments or a piece of dedicated DCI for a specific (i.e., single) user equipment.

In an exemplary embodiment, the bandwidth update indicator field may include at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment. And the instruction for updating the transmission bandwidth may be indicated by bits in the resource assignment field being all 1s or all 0s, or indicated by bits in the time domain resource assignment field being all 1s or all 0s.

In an exemplary embodiment, the size of the DCI is the same as the size of DCI format 1_0.

In an exemplary embodiment, the method in FIG. 4 further includes: scrambling the DCI using a preset Radio Network Temporary Identifier (RNTI).

It should be noted that the control method is performed by a network element equipment and corresponds to the data receiving method described above; please refer to the previous description on the data receiving method for details about the control method, and such details will not be repeated here.

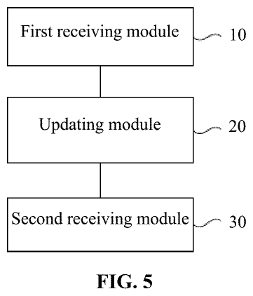

FIG. 5 is a block diagram of a data receiving device, according to an exemplary embodiment of this disclosure. For example, the data receiving device may be included in a user equipment. As shown in FIG. 5, the data receiving device may include a processor and a memory device for storing instructions executable by the processor. The processor may be configured to execute the instructions to implement a first receiving module 10, an updating module 20, and a second receiving module 30.

The first receiving module 10 is configured to receive Downlink Control Information (DCI), the DCI comprising a bandwidth update indicator field and a transmission bandwidth indicator field, the transmission bandwidth indicator field comprising transmission bandwidth information indicative of a frequency domain location.

The updating module 20 is connected to the first receiving module 10 and is configured to determine that the bandwidth update indicator field includes an instruction for updating a transmission bandwidth and, in response to the determining, update the transmission bandwidth based on the transmission bandwidth information.

The second receiving module 30 is connected to the updating module 20 and is configured to receive data using the updated transmission bandwidth.

Through the device above, the user equipment may receive the DCI, use the transmission bandwidth information to update the transmission bandwidth when the bandwidth update indicator field in the DCI indicates the transmission bandwidth to be updated, and receive data based on the transmission bandwidth information. In this disclosure, the transmission bandwidth may be updated dynamically based on the DCI's indication, allowing the transmission bandwidth to be updated to match dynamic network traffic demands as network traffic changes dynamically, thereby improving system efficiency and communication experience.

In an exemplary embodiment, the DCI is a piece of universal DCI for a plurality of user equipments or a piece of dedicated DCI for a specific (i.e., single) user equipment.

In an exemplary embodiment, in receiving the data using the transmission bandwidth information, second receiving module 30 is further configured to use the updated transmission bandwidth to receive the data in a time unit.

In an exemplary embodiment, in receiving the data using the transmission bandwidth information, second receiving module 30 is further configured to use the updated transmission bandwidth to receive the data in a plurality of time units.

In an exemplary embodiment, in receiving the data using the transmission bandwidth information, second receiving module 30 is further configured to use the updated transmission bandwidth to receive the data in one or more time units, until the user equipment receives another DCI for updating the transmission bandwidth.

In an exemplary embodiment, the time unit may include at least one of the following: a slot, a set of slots, a subframe, a frame, a symbol, or a set of symbols.

In an exemplary embodiment, in receiving DCI, the first receiving module 10 is further configured to descrambling the DCI using a preset Radio Network Temporary Identifier (RNTI).

In an exemplary embodiment, in receiving the data using the transmission bandwidth information, second receiving module 30 is further configured to determine, based on the frequency domain location, a Discrete Fourier Transform (DFT) length and a frequency domain resource mapped from a DFT output, and use the DFT length to perform an Inverse Discrete Fourier Transform (IDFT) on the received data.

In an exemplary embodiment, in receiving the data using the transmission bandwidth information, second receiving module 30 is further configured to determine, based on the frequency domain location, an Inverse IDFT input and an IDFT length, and use the IDFT input and IDFT length to perform an IDFT on the received data.

In an exemplary embodiment, in determining that the bandwidth update indicator field includes an instruction for updating a transmission bandwidth, the updating module 20 is further configured to determine, in response to the bandwidth update indicator field comprising preset indicator information, that the bandwidth update indicator field comprises the instruction for updating the transmission bandwidth.

In an exemplary embodiment, the bandwidth update indicator field may include at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment. And the instruction for updating the transmission bandwidth may be indicated by bits in the resource assignment field being all 1s or all 0s, or indicated by bits in the time domain resource assignment field being all 1s or all 0s.

In an exemplary embodiment, the size of the DCI is the same as the size of DCI format 1_0.

It should be noted that the data receiving device is a device configured to perform the data receiving method; please refer to the previous description on the data receiving method for details about the data receiving device, and such details will not be repeated here.

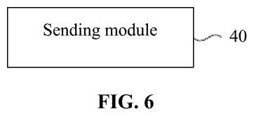

FIG. 6 is a block diagram of a control device, according to an exemplary embodiment of this disclosure. For example, the control device may be included in a network element equipment. As shown in FIG. 6, the control device may include a processor and a memory device for storing instructions executable by the processor. The processor may be configured to execute the instructions to implement a sending module 40.

Specifically, the sending module 40 is configured to send downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

Through the device above, this control device may send DCI that carries indication on whether to update the transmission bandwidth to provide indication to a user equipment, thus controlling the user equipment to update the transmission bandwidth when the bandwidth update indicator field is used to indicate the transmission bandwidth to be updated.

In an exemplary embodiment, the DCI is a piece of universal DCI for a plurality of user equipments or a piece of dedicated DCI for a specific (i.e., single) user equipment.

In an exemplary embodiment, the bandwidth update indicator field may include at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment. And the instruction for updating the transmission bandwidth may be indicated by bits in the resource assignment field being all 1s or all 0s, or indicated by bits in the time domain resource assignment field being all 1s or all 0s.

In an exemplary embodiment, the size of the DCI is the same as the size of DCI format 1_0.

In an exemplary embodiment, the control device further includes a scramble module (not shown in FIG. 6) connected to the sending module and configured to scramble the DCI using a preset Radio Network Temporary Identifier (RNTI).

It should be noted that the control device is a device configured to perform the control method; please refer to the previous description on the control method for details about the control device, and such details will not be repeated here.

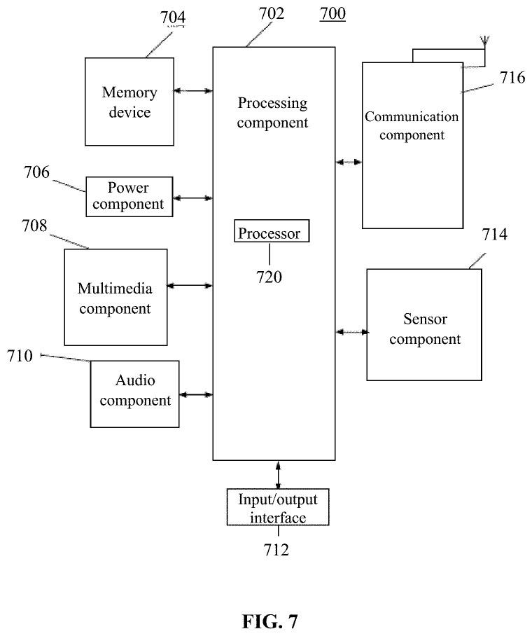

FIG. 7 is a block diagram of a data receiving device 700, according to an exemplary embodiment of this disclosure.

For example, the data receiving device 700 may be a mobile phone, computer, digital broadcast data receiving device, messaging equipment, game console, tablet equipment, medical equipment, fitness equipment, or Personal Digital Assistant.

Referring to FIG. 7, the data receiving device 700 may comprise one or a plurality of the following components: a processing component 702, a memory device 704, a power component 706, a multimedia component 708, an audio component 710, an input/output (I/O) interface 712, a sensor component 714, and a communication component 716.

Typically, the processing component 702 controls overall operations of the data receiving device 700, such as operations related to display, phone calls, data communication, camera operations, and recording operations. The processing component 702 may comprise one or a plurality of processors 720 to execute instructions to complete all or some of the steps in the aforementioned methods. Moreover, the processing component 702 may comprise one or a plurality of modules to facilitate interaction between the processing component 702 and other components. For example, the processing component 702 may comprise a multimedia module to facilitate interaction between the multimedia component 708 and the processing component 702.

The memory device 704 is configured to store data of various types to support operations on the data receiving device 700. Examples of such data include instructions, contacts data, phonebook data, messages, images, and videos used for any application or method operated on the data receiving device 700. The memory device 704 may be implemented as a volatile or non-volatile memory equipment of any type; such as a static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disk; or a combination thereof.

The power component 706 provides power to various components of the data receiving device 700. The power component 706 may comprise a power management system; one or a plurality of power supplies; and other components related to the generation, management, and assignment of power for the data receiving device 700.

The multimedia component 708 comprises a screen that provides an output interface between the data receiving device 700 and a user. In some embodiments, the screen may comprise a liquid crystal display (LCD) and a touch panel (TP). If the screen comprises a touch panel, the screen may be implemented as a touch screen to receive input signals from the user. The touch panel comprises one or a plurality of touch sensors to sense touches, slides, and gestures on the touch panel. The touch sensor may not only sense boundary of a touching or sliding action, but also detect the duration and pressure associated with a touching or sliding operation. In some embodiments, the multimedia component 708 comprises a front camera and/or a rear camera. When the data receiving device 700 is in an operating mode, such as a shooting mode or video mode, the front camera and/or the rear camera may receive external multimedia data. Each front camera and rear camera may be a fixed optical lens system or have the ability to adjust its focus and perform optical zooming.

The audio component 710 is configured to output and/or input audio signals. For example, the audio component 710 comprises a microphone (MIC); when the data receiving device 700 is in an operating mode, such as a call mode, record mode, and voice recognition mode, the microphone is configured to receive external audio signals. The audio signals received may further be stored in the memory device 704 or sent through the communication component 716. In some embodiments, the audio component 710 further comprises a speaker for outputting audio signals.

The I/O interface 712 provides an interface between the processing component 702 and a peripheral interface module, and the peripheral interface module may be a keyboard, click wheel, or button. Such a button may include but is not limited to: a home button, volume button, start up button, and lock button.

The sensor component 714 comprises one or a plurality of sensors for providing state assessment on various aspects for the data receiving device 700. For example, the sensor component 714 may detect the on/off state of the data receiving device 700 and relative positioning of components, such as a display and a keypad of the data receiving device 700. The sensor component 714 may also detect changes in the location of the data receiving device 700 or in the location of a component of the data receiving device 700, the existence or nonexistence of contact between the user and the data receiving device 700, the orientation or acceleration/deceleration of the data receiving device 700, and changes in the temperature of the data receiving device 700. The sensor component 714 may comprise a proximity sensor configured to detect the existence of nearby objects without any physical contact. The sensor component 714 may further comprise an optical sensor, such as a CMOS or CCD image sensor, for use in an imaging application. In some embodiments, the sensor component 714 may further comprise an accelerometer, gyro sensor, magnetic sensor, pressure sensor, or temperature sensor.

The communication component 716 is configured to facilitate wired or wireless communication between the data receiving device 700 and other equipment. The data receiving device 700 may access a communication standard-based wireless network, such as Wi-Fi, 2G, or 3G, 4G, 5G, 6G, 7G, or a combination thereof. In one exemplary embodiment, the communication component 716 receives broadcast signals or broadcast related information from an external broadcast management system through a broadcast channel. In one exemplary embodiment, the communication component 716 further comprises a near field communication (NFC) module to facilitate short-range communication. For example, the NFC module may be implemented based on radio frequency identification (RFID) technology, Infrared Data Association (IrDA) technology, ultra-wideband (UWB) technology, Bluetooth (BT) technology, or another technology.

In an exemplary embodiment, the data receiving device 700 may be implemented by one or a plurality of application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for executing the aforementioned methods.

An exemplary embodiment further provides a non-volatile computer readable storage medium, e.g. the memory device 704 that includes computer program instructions; the computer program instructions may be executed by the processor 720 of the data receiving device 700 to perform the aforementioned methods.

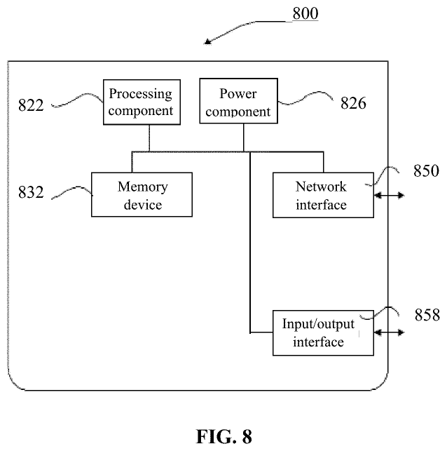

FIG. 8 is a block diagram illustrating a communication device 800, according to an exemplary embodiment of this disclosure. For example, the communication device 800 may be implemented as a control device in FIG. 6.

Referring to FIG. 8, the communication device 800 may be provided as a server. Referring to FIG. 8, the communication device 800 comprises a processing component 822, which comprises one or a plurality of processors, and a memory device resource represented by a memory device 832 for storing an instruction executable by the processing component 822 (e.g. an application). An application stored in the memory device 832 may comprise one or more modules, each corresponding to a set of instructions. Moreover, the processing component 822 may be configured to execute instructions to implement the aforementioned methods.

The communication device 800 may further comprise a power component 826 configured to execute power management for the communication device 800, a wired or wireless network interface 850 configured to connect the communication device 800 to a network, and an input/output (I/O) interface 858. The communication device 800 may operate an operating system stored in the memory device 832, for example, Windows Server™, Mac OS X™, Unix™, Linux™, FreeBSD™, or the like.

An exemplary embodiment further provides a non-volatile computer readable storage medium, e.g. the memory device 832 that includes computer program instructions; the computer program instructions may be executed by the processing component 822 of the communication device 800 to perform the aforementioned methods.

The disclosed embodiments may be implemented in a system, a method, and/or a computer program product. The computer program product may comprise a computer readable storage medium that includes computer readable program instructions used for causing the processor to implement various aspects of the disclosure.

The computer readable storage medium may be a tangible equipment capable of maintaining and storing instructions used by instruction-executing equipment. The computer readable storage medium may be, for example, but is not limited to an electrical memory equipment, magnetic memory equipment, optical memory equipment, electromagnetic memory equipment, semiconductor memory equipment, or any suitable combination thereof. More specific examples (a non-exhaustive list) of computer readable storage media include: portable computer disks, hard disks, random access memories (RAMs), read-only memories (ROMs), erasable programmable read-only memories (EPROMs or flash memories), static random-access memories (SRAMs), compact disc read-only memories (CD-ROMs), digital versatile disks (DVDs), memory sticks, floppy disks, mechanical coding equipments (such as punch cards or raised structures in grooves on which an instruction are stored), and any suitable combination thereof. The computer readable storage medium used here is not to be interpreted as transient signals themselves, such as radio waves, other electromagnetic waves freely propagated, other electromagnetic waves propagated through waveguides or other propagation media (for example, optical pulses through fiber optic cables), or other electrical signals transmitted through electrical wires.

The computer readable program instruction described here may be downloaded from the computer readable storage medium to various computing/processing equipments; or downloaded from a network, such as the Internet, a local area network (LAN), a wide area network (WAN), and/or a Wi-Fi network, to an external computer or an external memory equipment. The network may comprise a copper transmission cable, fiber optic transmission, wireless transmission, a router, a firewall, a switch, a gateway computer, and/or an edge server. A network adapter card or a network interface in each computing/processing equipment receives a computer readable program instruction from the network, and forwards the computer readable program instruction to be stored in a computer readable storage medium in a computing/processing equipment.

The computer program instruction for executing operations of the disclosure may be an assembly instruction, instruction set architecture (ISA) instruction, machine instruction, machine related instruction, microcode, firmware instruction, state setting data, or source code or object code written in one or any combination of a plurality of programming languages; the programming languages comprises an object-oriented programming language (such as Smalltalk and C++), a common procedural programming language (such as “C”), or a similar programming language. The computer readable program instruction may be executed entirely on a user computer, partially on a user computer, as a standalone software package, partially on a user computer and partially on a remote computer, or entirely on a remote computer or server. When a remote computer is involved, the remote computer may be connected to a user computer through a network of any type, including a LAN network or a WAN network; or, may be connected to an external computer (for example, connected through the Internet by using an Internet service provider). In some embodiments, an electrical circuit is customized by state information of a computer readable program instruction; such an electrical circuit may be a programmable logic circuit, field programmable gate array (FPGA), or programmable logic array (PLA); and the electrical circuit may execute a computer readable program instruction to implement various aspects in the disclosure.

Various aspects in the disclosure are described in reference to flowcharts and/or block diagrams of the methods, devices (systems), and computer program products in the embodiments in the disclosure. It should be understood that each block in the flowcharts and/or block diagrams and combinations of the blocks in the flowcharts and/or block diagrams may be implemented by computer readable program instructions.

These computer readable program instructions may be provided to a processor of a general purpose computer, a special purpose computer, or another programmable data processing device to produce a device that implements functions/actions specified in one or a plurality of blocks in the flowcharts and/or block diagrams, when these instructions are executed by the processor of the computer or the other programmable data processing device. These computer readable program instructions may also be stored in a computer readable storage medium, and these instructions cause a computer, a programmable data processing device, and/or another equipment to work in a certain way; thus, the computer readable medium that stores the instructions comprises a manufacture, which comprises instructions for implementing various aspects of functions/actions specified in one or a plurality of blocks in the flowcharts and/or block diagrams.

The computer readable program instructions may also be loaded to a computer, another programmable data processing device, or another equipment so that a series of operative steps are executed on the computer, the other programmable data processing device, or the other equipment to create a process of computer implementation, thereby causing functions/actions specified in one or a plurality of blocks in the flowcharts and/or block diagrams to be implemented by the instructions executed on the computer, the other programmable data processing device, or the other equipment.

The flowcharts and block diagrams in the drawings illustrate system architectures, functions, and operations that may be implemented by the systems, methods, and computer program products based on a plurality of embodiments in the disclosure. In this regard, each block in the flowcharts or block diagrams may represent a module, a program segment, or a part of an instruction; the module, program segment, or part of the instruction contains one or a plurality of executable instructions for implementing specified logical functions. In some alternative implementations, functions marked in the blocks may, alternatively, occur in an order different from that marked in the drawings. For example, depending on the functions involved, two consecutive blocks may, in fact, be executed in an essentially parallel way, and sometimes they may, alternatively, be executed in a reverse order. Also to be noted is that each block in the block diagrams and/or flowcharts and combinations of the blocks in the block diagrams and/or flowcharts may be implemented by a special purpose hardware-based system that executes specified functions or actions, or by a combination of special purpose hardware and computer instructions.

With respect to the embodiments in the disclosure described above, the descriptions are exemplary and not exhaustive, and are not limited to the disclosed embodiments. Without deviating from the scope and spirit of the embodiments described, modifications and changes may be evident for persons of ordinary skill in the art. Terminology choices in this disclosure are meant to best explain the principles and practical applications of the embodiments or improvements of technologies in the market, or to enable other persons of ordinary skill in the art to understand the embodiments disclosed in this disclosure.

What is claimed is:

1. A method for receiving data, the method comprising:
receiving Downlink Control Information (DCI), the DCI comprising a bandwidth update indicator field and a transmission bandwidth indicator field, the transmission bandwidth indicator field comprising transmission bandwidth information indicative of a frequency domain location;
determining that the bandwidth update indicator field includes an instruction for updating a transmission bandwidth;
in response to the determining that the bandwidth update indicator field includes the instruction for updating the transmission bandwidth, updating the transmission bandwidth based on the transmission bandwidth information; and
receiving the data using the updated transmission bandwidth.

2. The method of claim 1, wherein the DCI comprises universal DCI for a plurality of user equipments or dedicated DCI for a single user equipment.

3. The method of claim 1, wherein receiving the data using the updated transmission bandwidth comprises:
using the updated transmission bandwidth to receive the data in one or more time units.

4. The method of claim 3, wherein each of the one or more time units comprises one of: a slot, a set of slots, a subframe, frame, a symbol, or a set of symbols.

5. The method of claim 1, wherein receiving the data using the updated transmission bandwidth comprises:
using the updated transmission bandwidth to receive the data in one or more time units, until the user equipment receives second DCI for updating the transmission bandwidth.

6. The method of claim 5, wherein each of the one or more time units comprises one of: a slot, a set of slots, a subframe, frame, a symbol, or a set of symbols.

7. The method of claim 1, wherein receiving the DCI comprises:
descrambling the DCI using a preset Radio Network Temporary Identifier (RNTI).

8. The method of claim 1, wherein receiving the data using the updated transmission bandwidth comprises:
determining, based on the frequency domain location, a Discrete Fourier Transform (DFT) length and a frequency domain resource mapped from a DFT output, and using the DFT length to perform an Inverse Discrete Fourier Transform (IDFT) on the received data; or
determining, based on the frequency domain location, an Inverse IDFT input and an IDFT length, and using the IDFT input and IDFT length to perform an IDFT on the received data.

9. The method of claim 1, wherein determining that the bandwidth update indicator field includes an instruction for updating a transmission bandwidth comprises:
determining, in response to the bandwidth update indicator field comprising preset indicator information, that the bandwidth update indicator field comprises the instruction for updating the transmission bandwidth.

10. The method of claim 1, wherein the bandwidth update indicator field comprises at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment; and
wherein the instruction for updating the transmission bandwidth is indicated by bits in the resource assignment field being all 1s or all 0s, or indicated by bits in the time domain resource assignment field being all 1s or all 0s.

11. The method of claim 1, wherein the DCI has a size same as a size of DCI format 1_0.

12. A method performed by a network element equipment, the method comprising:
sending downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

13. The method of claim 12, wherein the DCI comprises universal DCI for a plurality of user equipments or dedicated DCI for a single user equipment.

14. The method of claim 12, wherein the bandwidth update indicator field comprises at least one of a resource assignment field or a time domain resource assignment field, the resource assignment field being used for indicating frequency domain resource assignment or sample-level time domain resource assignment, the time domain resource assignment field being used for indicating Orthogonal Frequency-Division Multiplexing (OFDM) symbol-level time domain resource assignment; and
wherein the instruction for updating the transmission bandwidth is indicated by bits in the resource assignment field being all 1s or all 0s, or indicated by bits in the time domain resource assignment field being all 1s or all 0s.

15. The method of claims 12, wherein the DCI has a size same as a size of DCI format 1_0.

16. The method of claim 12, further comprising:
scrambling the DCI using a preset Radio Network Temporary Identifier (RNTI).

17. A data receiving device, comprising:
a processor;
a memory device for storing instructions executable by the processor;
wherein the processor is configured to execute the instructions to:
receive Downlink Control Information (DCI), the DCI comprising a bandwidth update indicator field and a transmission bandwidth indicator field, the transmission bandwidth indicator field comprising transmission bandwidth information indicative of a frequency domain location;
determine that the bandwidth update indicator field includes an instruction for updating a transmission bandwidth;
in response to the determining that the bandwidth update indicator field includes the instruction for updating the transmission bandwidth, update the transmission bandwidth based on the transmission bandwidth information; and
receive data using the updated transmission bandwidth.

18. A control device, comprising:
a processor;
a memory device for storing instructions executable by the processor;
wherein the processor is configured to execute the instructions to:
send downlink control information (DCI), the DCI comprising a bandwidth update indicator field and a transmission bandwidth indicator field, the bandwidth update indicator field indicating whether to update a transmission bandwidth, the transmission bandwidth indicator field comprising transmission bandwidth information indicative of a frequency domain location.

19. A non-transitory computer readable storage medium storing a computer program that, when executed by a processor, causes the processor to perform a method for receiving data, the method comprising:
receiving Downlink Control Information (DCI), the DCI comprising a bandwidth update indicator field and a transmission bandwidth indicator field, the transmission bandwidth indicator field comprising transmission bandwidth information indicative of a frequency domain location;
determining that the bandwidth update indicator field includes an instruction for updating a transmission bandwidth;
in response to the determining that the bandwidth update indicator field includes the instruction for updating the transmission bandwidth, updating the transmission bandwidth based on the transmission bandwidth information; and
receiving the data using the updated transmission bandwidth.

20. A non-transitory computer readable storage medium storing a computer program that, when executed by a processor, causes the processor to perform a method, the method comprising:
sending downlink control information (DCI), the DCI comprising a bandwidth update indicator field and a transmission bandwidth indicator field, the bandwidth update indicator field being used for indicating whether to update a transmission bandwidth, the transmission bandwidth indicator field comprising transmission bandwidth information indicative of a frequency domain location.
